(19) United States
(12) Patent Application Publication
(10) Pub. No.: US 2018/0044927 A1
(43) Pub. Date: Feb. 15, 2018

(54) Silo Inspection Lift And Systems And Methods For Using Same

(71) Applicant: SILO ACCESS EQUIPMENT LLC, Griffin, GA (US)

(72) Inventors: JEFFREY WILLIAM WARNOCK, Griffin, GA (US); HOBIE HUGHES, Florence, MS (US)

(21) Appl. No.: 15/677,852

(22) Filed: Aug. 15, 2017

Related U.S. Application Data
(60) Provisional application No. 62/375,006, filed on Aug. 15, 2016.

(51) Int. Cl. E04G 1/22; E04G 3/28

(52) U.S. Cl. CPC E04G 1/22; E04G 3/28; A01B 63/10

(57) ABSTRACT

A silo inspection lift having a base, a vertical support, and a basket. The vertical support extends from the base and has a top end. The vertical support has at least one support arm that is selectively extendable and retractable relative to a vertical axis. The basket is secured to the top end of the vertical support. The basket defines an interior space configured to receive at least one human, such as an inspector of a silo. Systems and methods for using the silo inspection lift are also disclosed.

### CROSS-REFERENCE TO RELATED APPLICATION

This application claims priority to and the benefit of the filing date of U.S. Provisional Patent Application No. 62/375,006, filed Aug. 15, 2016, which application is incorporated herein by reference in its entirety.

### FIELD

The disclosure relates to an apparatus and method for safely inspecting the interior portions of a silo, such as, for example, a hot mix asphalt silo.

### BACKGROUND

Asphalt producing plants make hot mix asphalt (referred to as HMA plants). HMA plants can be either a batch plant or a continuous mix process plant. These plants heat and dry aggregate to temperatures of 180-350 degrees Fahrenheit. Then, a required amount of hot liquid asphalt is applied to the heated aggregate. This process is, in most cases, controlled by one or more computers. After the hot liquid and aggregate merge together a mixing process takes place. The final product is hot mix asphalt.

Most plants have a need to store the product. For example, some batch plants and almost all continuous mix plants have storage silos. Silos can typically hold from 80 tons up to 330 tons of HMA. The most typical size silos hold 200 tons and are 12 feet in diameter. Silos can stand upwards of 50 feet tall, consisting of an inner barrel and a cone at the bottom discharge area. There is typically insulation around the outside of the barrel and a thin outer aluminum shell or metal jacket that is either painted or lettered with a company name or logo.

These silos are filled by either a drag slat conveyor that “drags” the mix to the top of the silo or a bucket elevator that lifts the mix to the top of the silo. The mix is then deposited into a collector on the top of the silo called a batcher. Batchers can typically hold from two to 10 tons of hot mix depending upon the size and speed of a given plant. The batcher prevents the mix from segregating as it falls through the air into the silo. The larger or heavier aggregate tends to fall faster than the lighter aggregate. But by collecting HMA in a batcher and dropping it together in a “slug” into the silo, less segregation occurs.

Usually, HMA transport trucks drive onto a metal platform truck scale and under storage silos for loading. Some silos have built in load cells that do not require truck scales. When a plant operator or loadout computer loads a truck, a signal is given for an air operated door or a gate covering the silo discharge hole to open just above the trucks, allowing the HMA to fall from the silo cone opening into the truck body. The weight and/or amount of mix is typically indicated on a scale readout device in the control room. A “ticket” or receipt is then printed and the truck pulls out from under the silo and the driver receives a ticket with the truck tare weight and gross weight along with the HMA net weight printed on it. The truck leaves the plant site en route to a work site, such as the location of a paving job.

Abrasions occur after many thousands of tons of HMA have been dropped from the batchers into the silos and then discharged into trucks. Impact from batcher drops, and sliding of hot mix into the trucks from the silo barrel and down into the cone can cause these abrasions. Over time, the abrasions can wear into the steel along with its welded seams on the inside structure of the silos. Silo manufacturers and aftermarket vendors do offer “silo liners” that are typically made of either ceramic or steel and can be installed inside of HMA silos to accommodate abrasion. Some plant owners opt to not purchase liners and install them themselves or contract a third party to install them at a later date. Some plant owners cover the entire inside area inside of silos, while others only cover the cone area near the discharge gate, and while still others do not invest in liners at all.

Periodically, someone is badly burned or killed because of silos that have worn down to a point that will not support the designed weight load. The weld that attaches the cone to the lower end of the barrel and other structural welds along with metal surfaces can wear down to a critical thickness and separate or wear through. When this happens, the plant operator has no control of the amount of hot mix, or quantity that is leaking out or falling into trucks or onto the scale or the ground. In some incidents, people and/or trucks have been buried and burned in 325 degrees Fahrenheit hot mix. In other incidents, truck hoods have been covered and their windshields have collapsed under the weight of HMA, severely injuring and burning drivers and passengers. Although plant managers and/or owners of HMA plants do general plant maintenance, with all of the many moving parts and wear issues in a plant, the silos often get overlooked, particularly in view of the difficulties obtaining safe access for inspection.

In one conventional inspection method, the inspection is performed with the use of a ladder or man lift that gets personnel up 12-16 feet into the small cone opening of the silo. Different silo manufacturers have different sized discharge openings, from 12″ rectangular openings to 40″ round openings. Some silo manufacturers even incorporate up to three openings at the cone bottom. From there, another ladder has to be pulled up into the cone discharge hole and then somehow propped up on the cone wall (6′ to 12′) and then a climber climbs the cone. This can be 11 to 12 feet up to where the cone and barrel meet at a welded seam. This only allows the climber to check the wall thickness and weld seams in the proximity of the ladder. Meanwhile the discharge hole of the cone is blocked by a ladder, making emergency evacuation difficult.

Another conventional inspection method requires welding support braces to the cone walls and the building of makeshift scaffolding, with each section being assembled as the inspectors ascend the silo without knowing the thickness of the materials to which the support braces are being welded. This process becomes particularly difficult when the inside of a silo is covered with ceramic wear tiles.

Most companies have an Environmental Health and Safety Officer that frowns upon use of either of these conventional inspection methods. Typically, if neither conventional inspection method is used, an inspector stands on the ground, man lift, or scale while the silo operator opens the silo gates from the control house. With the silo gates open, the inspector can shine a flashlight into a small hole (that is typically 12-16 feet above the inspector) to permit a visual inspection of a portion of the interior of the silo. This approach is inadequate and unreliable for providing a meaningful and detailed inspection of the silo.

As can be seen, there is a need for an improved method and apparatus to access the inside of HMA silos to help and assist owners and managers of plants make maintenance decisions relating to HMA silos.

### SUMMARY

Described herein, in various aspects, is a silo inspection lift having a base, a vertical support, and a basket. The vertical support can extend from the base and have a top end. The vertical support can comprise at least one support arm that is selectively extendable and retractable relative to a vertical axis. The basket can be secured to the top end of the vertical support. The basket can define an interior space configured to receive at least one human, such as an inspector of a silo.

In additional aspects, described herein is a system having a trailer and a silo inspection lift that is secured to the trailer. The silo inspection lift can have a base, a vertical support, and a basket. The vertical support can extend from the base and have a top end. The vertical support can comprise at least one support arm that is selectively extendable and retractable relative to a vertical axis. The basket can be secured to the top end of the vertical support. The basket can define an interior space configured to receive at least one human, such as an inspector of a silo. The base of the silo inspection lift can be pivotally coupled to the trailer to permit selective movement of the silo inspection lift about and between a horizontal, stowed position and a vertical, use position.

Also described is a method of inspecting a silo having an interior space and a discharge opening positioned in fluid communication with the interior space. The method can include positioning a silo inspection lift in a vertical, use position. The silo inspection lift can have a base, a vertical support, and a basket. The vertical support can extend from the base and have a top end. The vertical support can comprise at least one support arm that is selectively extendable and retractable relative to a vertical axis. The basket can be secured to the top end of the vertical support. With an inspector positioned within the basket of the silo inspection lift, the method can also include selectively extending the vertical support until the basket containing the inspector passes through the discharge opening and is received within the interior space of the silo. After the inspector has performed an inspection of the silo, the method can include selectively retracting the vertical support until the basket exits the silo.

As further described herein, it is contemplated that the base of the silo inspection lift can be selectively moveable within an X-Y plane that is perpendicular to a vertical axis, thereby permitting selective side-to-side or lateral movement of the lift relative to a silo. In use, it is contemplated that this selective movement within the X-Y plane can assist with lining up the basket of the lift with the discharge opening of the silo. Additionally, this selective movement within the X-Y plane can allow the basket to be fully shifted to one side of the interior space of the silo, thereby providing sufficient space for an inspector to pass through the discharge opening of the silo during an emergency evacuation.

Additional advantages of the disclosure will be set forth in part in the description which follows, and in part will be obvious from the description, or may be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DESCRIPTION OF THE DRAWINGS

These and other features of the preferred embodiments of the disclosure will become more apparent in the detailed description in which reference is made to the appended drawings wherein:

FIGS. 1A-1B are side views of an exemplary lift in a vertical, use position as disclosed herein. As shown, the lift can be positioned on a trailer. Optionally, as shown in FIG. 1A, the trailer can be provided with a ladder platform to assist an inspector with entry or exit from a basket of the lift. Optionally, as shown in FIG. 1B, the trailer can be provided with stairs to assist an inspector with entry or exit from a basket of the lift. FIG. 1C is a side view of an exemplary lift in a horizontal, stowed position as disclosed herein.

FIG. 2A is a side view of an exemplary basket of a lift as disclosed herein, with the support platform of the basket in a retracted position. FIG. 2B is a side view of the basket of FIG. 2A, with the support platform in a deployed position. FIG. 2C is a top view of the basket of FIG. 2A. FIG. 2D is a bottom view of the basket of FIG. 2A.

FIG. 3 is a side view of an exemplary system including a lift and a trailer as disclosed herein.

FIG. 4 is a schematic diagram depicting communication between various components that are capable of controlling operation of a lift as disclosed herein.

### DETAILED DESCRIPTION

The present disclosure now will be described more fully hereinafter with reference to the accompanying drawings, in which some, but not all embodiments of the disclosure are shown. Indeed, this disclosure may be embodied in many different forms and should not be construed as limited to the embodiments set forth herein; rather, these embodiments are provided so that this disclosure will satisfy applicable legal requirements. Like numbers refer to like elements throughout. It is to be understood that this disclosure is not limited to the particular methodology and protocols described, as such may vary. It is also to be understood that the terminology used herein is for the purpose of describing particular embodiments only, and is not intended to limit the scope of the present disclosure.

Many modifications and other embodiments of the disclosure set forth herein will come to mind to one skilled in the art to which the disclosure pertains having the benefit of the teachings presented in the foregoing description and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

As used herein the singular forms “a”, “an”, and “the” include plural referents unless the context clearly dictates otherwise. For example, use of the term “a support platform” can refer to one or more of such support platforms unless the context indicates otherwise.

All technical and scientific terms used herein have the same meaning as commonly understood to one of ordinary skill in the art to which this disclosure belongs unless clearly indicated otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

The word “or” as used herein means any one member of a particular list and also includes any combination of members of that list.

The following description supplies specific details in order to provide a thorough understanding. Nevertheless, the skilled artisan would understand that the apparatus and associated methods of using the apparatus can be implemented and used without employing these specific details. Indeed, the apparatus and associated methods can be placed into practice by modifying the illustrated apparatus and associated methods and can be used in conjunction with any other apparatus and techniques conventionally used in the industry.

Disclosed herein, in various aspects, is a lift that provides safe access into the interior of silos (e.g., HMA silos) for the purpose of inspection and/or light maintenance. As further disclosed herein, the lift can include a hydraulically operated unit. Additionally or alternatively, the disclosed lift can also incorporate a multi stage hydraulic lift cylinder attached to an “X-Y” axis base, and a specially designed basket attached to its top. Optionally, the basket can have a fold down walkway extending therefrom. In use, the multi stage lift cylinder can allow the basket to be raised and lowered according to operator preference and positioning requirements once inside the silo. It is contemplated that the disclosed lift can allow personnel to be lifted up into silos for inspection and/or repair, giving access to the area inside of hot mix storage silos that has not previously been accessed easily and safely.

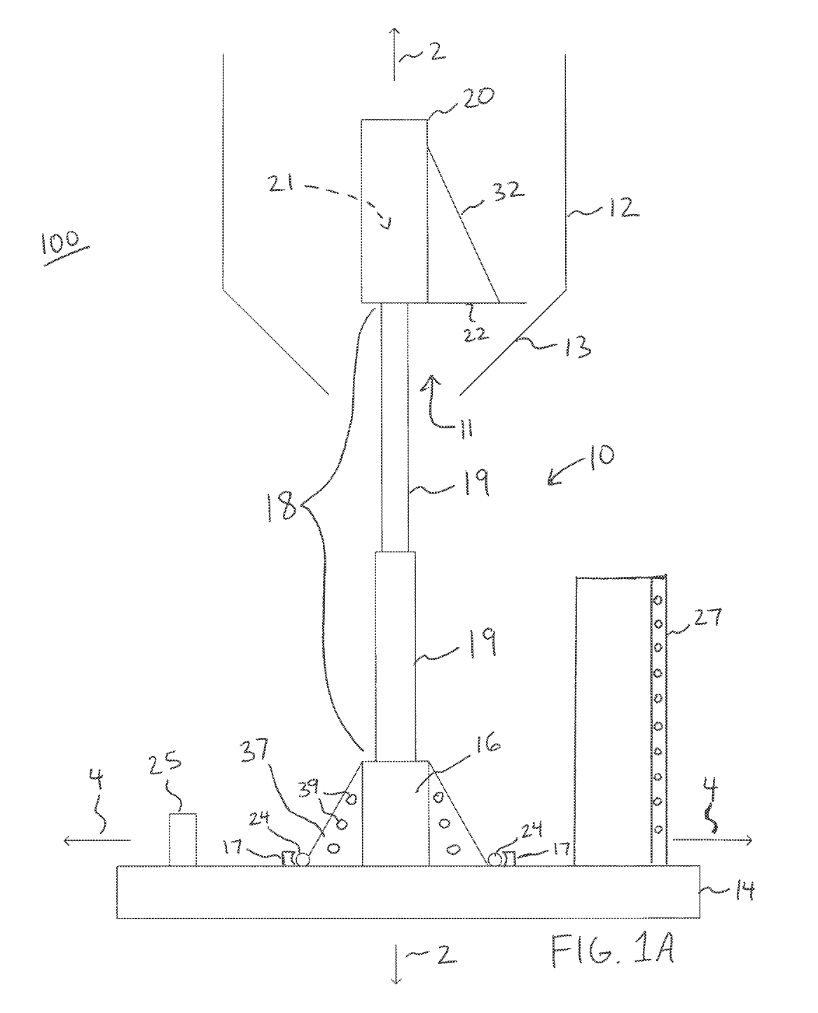

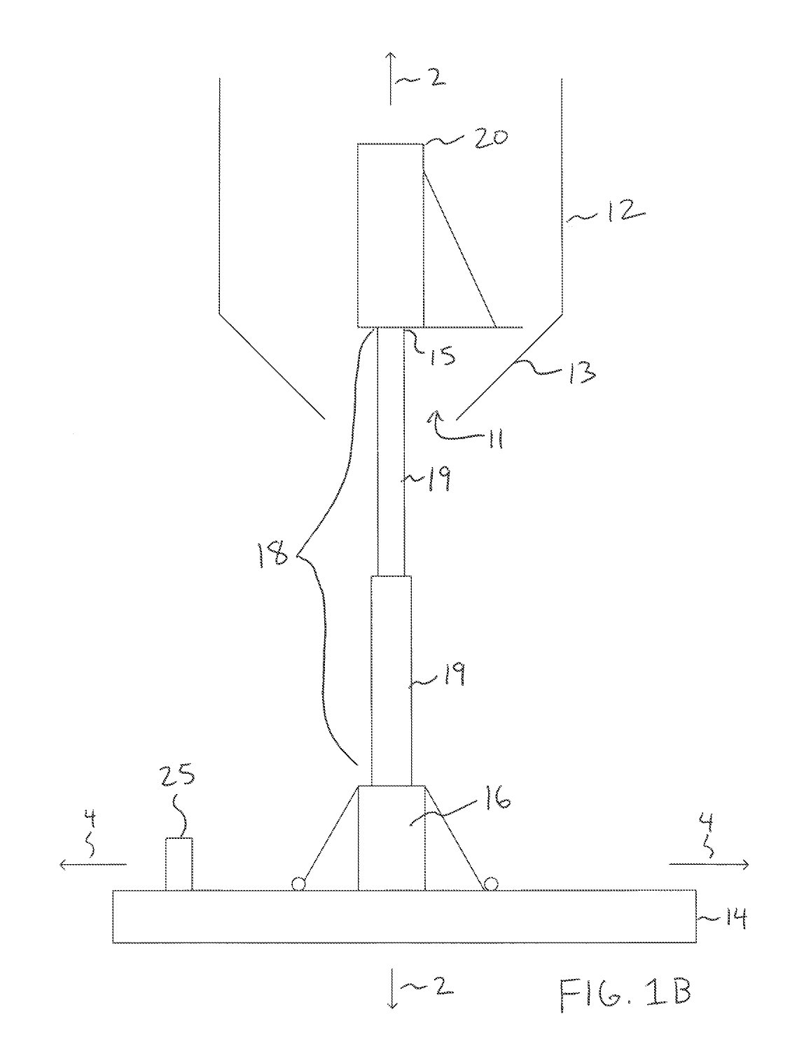

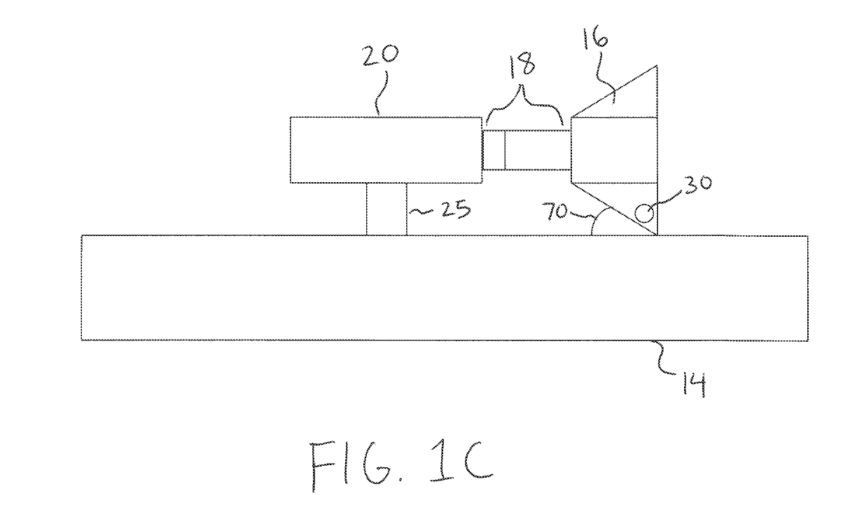

Referring to FIGS. 1A-4, a lift 10 as disclosed herein can comprise a base 16, a vertical support 18, and a basket 20. In use, the base 16 can support the lift 10 in an upright position. The vertical support 18 can be secured to the base 16 and can move upwards and downwards relative to a vertical axis 2. The basket 20 can be secured to a top end 15 of the vertical support 18 and can have an interior space 21 that is sized and shaped to fit at least one person within it. In use, the vertical support 18 can lift the basket 20 into a silo 12 so that the person (e.g., the inspector) within the basket 20 is in position to inspect the inside (interior space) of the silo 12. As further disclosed herein, the silo 12 can have an interior space and a discharge opening 11 positioned in fluid communication with the interior space. Optionally, the discharge opening 11 can be defined within a cone portion 13 of the silo 12.

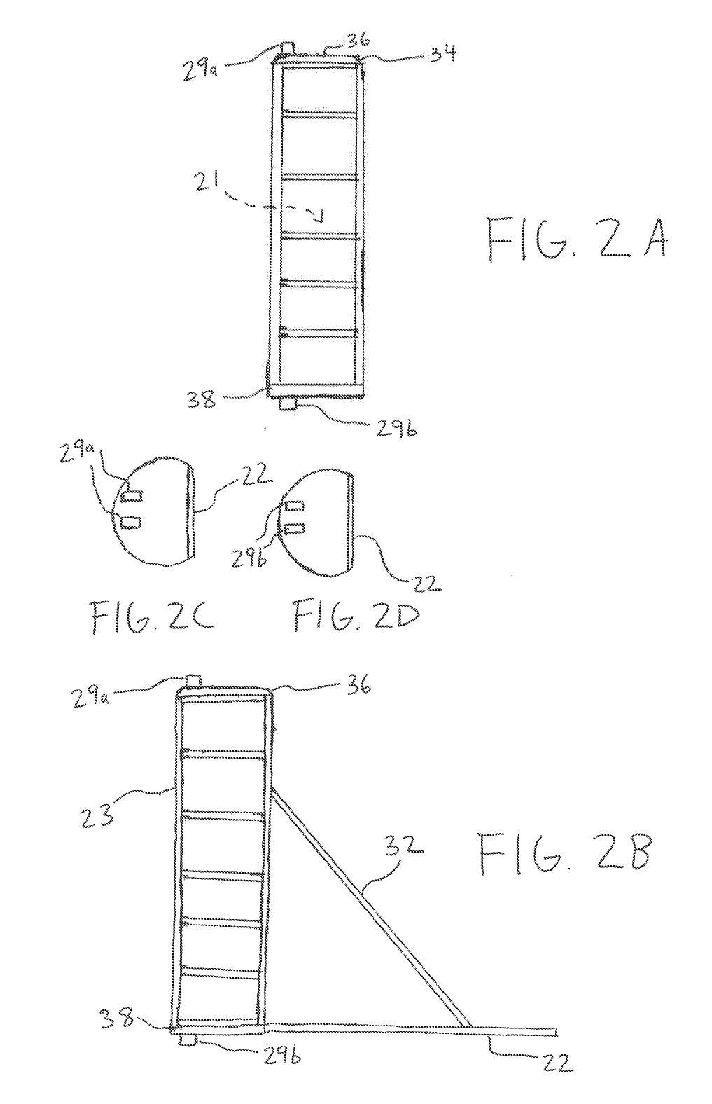

In exemplary aspects, the basket 20 can comprise a frame 23 and at least one support platform 22 that is coupled to the frame and selectively moveable about and between a retracted (e.g., folded) position and a deployed position. It is further contemplated that the basket 20 can comprise a lock that is configured to secure the at least one support platform 22 in the retracted position until it is necessary to make use of the support platform. Optionally, as shown in FIGS. 1A-1B and 2B, in the deployed position, each support platform 22 can extend perpendicularly or substantially perpendicularly to the vertical axis 2. In the retracted position, it is contemplated that each support platform 22 can optionally be positioned in a vertical or substantially vertical orientation. Optionally, in the retracted position, each support platform 22 can cooperate with portions of the frame 23 to define the interior space 21 of the basket 20. In use, following deployment of each support platform 22, the support platform can be configured to support the at least one human (e.g., inspector) when the at least one human is positioned on the platform, thereby permitting close inspections of the inner sidewall of the silo 12.

Optionally, in exemplary aspects, and with reference to FIGS. 2C-2D, when the at least one support platform 22 is in the retracted position, the basket 20 can have an outer diameter ranging from about 12 inches to about 60 inches, and more preferably from about 15 inches to about 40 inches or from about 18 inches to about 30 inches. Optionally, it is contemplated that the outer diameter of the basket 20 can be less than 24 inches. However, it is contemplated that any outer diameter can be used, provided the basket 20 is capable of passage through the opening 11 of the silo 12 as further disclosed herein. Optionally, as shown in FIGS. 2C-2D, when the at least one support platform 22 is positioned in the retracted position, each support platform can define a substantially planar (flat) portion of the perimeter (outer diameter) of the basket 20. In the example depicted in FIGS. 2C-2D, only a single support platform 22 is depicted, with the remaining portions of the perimeter of the basket having a uniform or substantially uniform radius of curvature; however, it is contemplated that the basket can be equipped with a plurality of circumferentially spaced support platforms 22 as further disclosed herein. In the example depicted in FIGS. 2A-2D, it is contemplated that the support platform can have a length (relative to the vertical axis when in the retracted position) of at least six feet (optionally, a length of about six feet) or at least seven feet. It is further contemplated that the support platform can have a width of at least 12 inches or at least 15 inches or, more preferably, ranging from about 12 inches to about 30 inches. In this example, it is contemplated that the total length of the basket (relative to the vertical axis) can range from about six feet six inches to about 10 feet. Optionally, it is contemplated that the total length of the basket can be at least six feet, at least six feet six inches, at least seven feet, or at least eight feet. Thus, it is contemplated that the length of the basket can be sufficient to provide an interior space that is capable of receiving an inspector in a standing position.

In exemplary aspects, each support platform 22 of the at least one support platform can be pivotally attached to the frame 23 of the basket 20. Optionally, in these aspects, each support platform 22 can be pivotally attached to the frame 23 at a hinge, which in some configurations can be spring-loaded toward the retracted position. Optionally, it is further contemplated that the hinge connecting the support platform 22 to the basket 20 can be configured to prevent pivotal movement of the support platform beyond the deployed position disclosed herein. For example, the hinge can optionally be coupled to a stop feature that is configured to engage a portion of the basket 20 (e.g., the frame 23) and prevent further pivotal movement of the support platform 22 once the support platform reaches the deployed position. Optionally, the basket 20 can comprise a latch, a lock, a fastener, or other conventional retention mechanism that is capable of securing the at least one support platform 22 to the frame 23 of the basket such that the at least one support platform 22 remains in the retracted position until the inspector wishes to deploy the support platform. It is contemplated that such retention mechanisms can be selectively activated/engaged or inactivated/disengaged as needed during use of the lift. Thus, when an inspector wishes to deploy a given support platform 22, the corresponding retention mechanism can be selectively inactivated or disengaged to permit movement of the support platform from the retracted position to the deployed position. Additionally, or alternatively, in some aspects, the basket 20 can comprise at least one platform actuator (not shown) that is operatively coupled to the at least one support platform 22 and configured for selective activation to effect selective movement (optionally, pivotal movement) of each respective support platform 22 about and between the retracted position and the deployed position. Optionally, the platform actuator can comprise a linear or rotational actuator as is known in the art, such as for example and without limitation, a hydraulic actuator. However, it is contemplated that the at least one platform actuator can comprise any conventional actuator that is capable of effecting movement of the at least one support platform 22 as disclosed herein. In use, it is contemplated that the platform actuator can be communicatively coupled (through wireless or wired connection) to a control panel 40 or controller 50 as further disclosed herein. Additionally, or alternatively, it is contemplated that each platform actuator can be communicatively coupled to a user interface (such as, for example and without limitation, one or more buttons) that can be selectively engaged by an inspector within the basket to effect selective movement of each support platform 22.

Optionally, it is contemplated that the at least one support platform 22 can comprise a plurality of support platforms 22 that are circumferentially spaced about an outer diameter of the basket 20. Optionally, in these aspects, when the plurality of support platforms 22 are deployed, it is contemplated that at least one of the support platforms can be positioned at a different vertical position (relative to the vertical axis 2) than at least one other support platform of the plurality of support platforms. Alternatively, it is contemplated that each support platform can be deployed at substantially the same vertical position.

Optionally, in some exemplary aspects, it is contemplated that at least one of the support platforms 22 can be deployed to assist an inspector during entry and exit from the basket 20. Optionally, in these aspects, it is contemplated that at least one support platform can be configured to pivot more than 90 degrees (from the vertical, retracted position) to function as a ramp that extends downwardly from the basket and can provide a transition between the basket 20 and a support surface closer to the ground (e.g., a platform, a ladder, stairs, a trailer or truck bed, and the like). Additionally, or alternatively, it is contemplated that the basket can comprise a fold-down ladder that can be selectively deployed to extend between the interior space 21 of the basket 20 and a support surface closer to the ground (e.g., a platform, a ladder, stairs, a trailer or truck bed, and the like).

Optionally, in still further exemplary aspects, it is contemplated that at least one of the support platforms 22 can be provided with a reinforcement arm 32 that extends between an a portion of the frame 23 of the basket 20 and an outer edge of the support platform. As depicted in FIG. 2B, when the support platform is deployed, the reinforcement arm can extend substantially linearly between the frame 23 and the support platform, thereby reinforcing the stability of the support platform, particularly when the inspector is positioned on the support platform. Optionally, the support platform can be equipped with at least two reinforcement arms 32 positioned on opposite sides of the support platform. Optionally, the reinforcement arms 32 can comprise cable, chain, rope, straps or other conventional support structures that are capable of supporting a support platform in a deployed position as disclosed herein. Optionally, in one exemplary aspect, the reinforcement arms can comprise telescopically coupled arm segments that are capable of extension and retraction with the support platform as disclosed herein. However, it is contemplated that any conventional reinforcement/support arm of this type can be used. Optionally, it is contemplated that the reinforcement arm can be operatively coupled to or provided as a part of a platform actuator as disclosed herein; for example, it is contemplated that the reinforcement arm can be a portion of a linear actuator that is selectively extendable and retractable to effect deployment or retraction of the support platform.

In exemplary aspects, it is contemplated that the basket 20 can comprise top and bottom cover plates 36, 38 that are welded, bolted, or otherwise permanently secured to the opposed ends of the frame 23 of the basket. As shown in FIGS. 2A-2B, it is contemplated that the frame 23 of the basket 20 can have a chamfered top end 35 to which the top cover plate 36 is secured. As depicted, the chamfered top end 35 can be inwardly tapered moving toward the top cover plate 36. Optionally, the chamfered top end 35 can be inwardly tapered at an angle ranging from about 10 degrees to about 60 degrees or, more preferably, from about 20 degrees to about 45 degrees relative to the vertical axis 2. In use, it is contemplated that the chamfered top end 35 of the frame 23 can assist a lift operator in clearing the discharge opening 11 of the silo 12 as the basket enters the opening.

In exemplary aspects, the vertical support 18 can comprise at least one support arm 19 that is selectively extendable and retractable relative to a vertical axis 2. In further exemplary aspects, the vertical support 18 can comprise a linear actuator that is configured to effect selective axial movement of the basket 20 relative to the vertical axis 2. Optionally, in these aspects, the linear actuator can comprise a telescopic hydraulic cylinder comprising plurality of telescopically coupled support arms 19. Optionally, when the linear actuator comprises a telescopic hydraulic cylinder, it is contemplated that the hydraulic cylinder can comprise a base cylinder that is provided as part of base 16 and a plurality of telescopically coupled support arms 19 that extend vertically upwardly from the base cylinder. Optionally, it is contemplated that the uppermost support arm 19 can have an outer diameter ranging from about 4 inches to about 12 inches, and more preferably from about 4 inches to about 8 inches or being about 6 inches. As further disclosed herein, it is contemplated that the outer diameter of the uppermost support arm can be sufficiently small to permit passage of an inspector through the discharge opening of the silo while the basket is within the interior space of the silo. Although the specific example of a hydraulic cylinder has been disclosed, the vertical support 18 is not limited to such and may be other types of linear actuators. It is contemplated that the vertical support 18 can be powered by an on board power system or by external power sources.

Optionally, in additional aspects, the basket 20 can be selectively rotatable relative to the vertical axis 2. Optionally, in these aspects, it is contemplated that the basket 20 can be rotatably coupled to the vertical support 18. However, it is also contemplated that the vertical support 18 can be configured for rotational movement along with the basket 20; for example, when cylinders within the vertical support are not fully extended, it is contemplated that the cylinders can rotate with the basket 20. Optionally, in some aspects, it is contemplated that the inspector (or other individual positioned within the basket) can be configured to manually rotate the basket 20 by pushing on the inner wall of the silo 12, thereby effecting rotational movement of the basket relative to the vertical axis 2. Alternatively, in further optional aspects, it is contemplated that the basket 20 can be operatively coupled to a rotational actuator, such as a motor 60. It is contemplated that the rotational actuator 60 can be selectively activated to effect rotational motion of the basket 20 relative to the vertical axis (and the vertical support). Optionally, the rotational actuator (e.g., motor 60) can be positioned underneath the basket 20. In use, it is contemplated that rotation of the basket 20 can permit up to a 360-degree inspection of the interior of the silo.

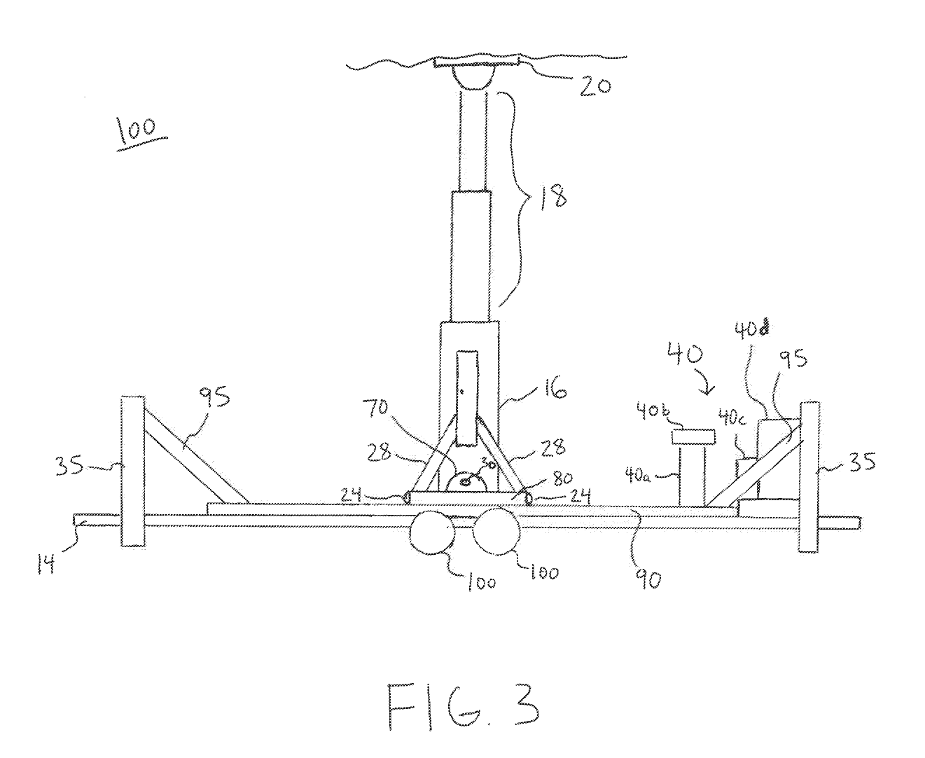

Optionally, in further aspects, the base 16 can comprise a base body 37. Optionally, in some aspects, the base 16 can further comprise at least one linear guide slide 17. In these aspects, the base body 37 can be movably coupled to the at least one linear guide slide 17 to permit selective axial movement of the base body within an X-Y plane 4 that is perpendicular to the vertical axis 2. Optionally, the base 16 can further include rollers 24 or ball bearings that allow the base 16 to be movably coupled to the at least one linear guide slide 17, thereby permitting side-to-side or front-and-back movement (optionally, movement relative to two axes in the X-Y plane 4). In exemplary aspects, the at least one linear guide slide 17 can comprise a plurality of linear guide slides that are operatively coupled to an X and Y slide base 16 to permit sliding movement of the base within X-Y plane 4, which is perpendicular to vertical axis 2. Optionally, in these aspects, at least two hydraulic cylinders 28 can be operatively coupled to the base body to effect selective movement of the lift along the at least one linear guide slide 17 (within the X-Y plane 4, and forward, backward, left or right relative to the silo 12). Additionally, or alternatively, in further aspects, and as shown in FIG. 3, the base 16 can comprise a translation platform or flatbed trolley/dolly 80, which can comprise a flat platform and a plurality of rollers, wheels, or casters 24, and which can be secured to a bottom portion of the base 16. Optionally, in these aspects, it is contemplated that at least two hydraulic cylinders 28 can be operatively coupled to the translation platform 80 to guide movement of the base within the X-Y plane as disclosed herein. It is further contemplated that the base 16 can comprise at least one guide element or receptacle with stop elements for confining the range of movement of the base 16 relative to the X-Y plane.

In use, the disclosed configurations can allow users to shift the lift 10 to one side of the silo 12 so that the discharge opening 11 of the silo can have enough clearance to allow an inspector to pass through the discharge opening (such as when an emergency evacuation from the silo is necessary). For example, if the vertical support remains centrally positioned within the discharge opening, it may be difficult for an inspector to pass through the discharge opening; however, if the vertical support can translate in a lateral or horizontal direction, additional clearance can be provided.

Optionally, when a plurality of linear guide slides 17 are provided, it is contemplated that the linear guide slides can be provided as part of a linear translation stage that permits movement of the base 16 within an X-Y plane 4 as disclosed herein. It is contemplated that the disclosed linear guide slides can be manually operated or powered by pneumatic actuators, hydraulic actuators, or motors as are known in the art. Exemplary linear guide slides include the ball bearing and roller-style linear guide slides produced by Gilman Precision (Grafton, Wis.). Although described herein as including at least one linear guide slide 17, it is contemplated that any linear translation mechanism configured to permit movement of the base 16 within an X-Y plane 4 as disclosed herein can be used. Thus, it is contemplated that conventional translation mounts, translation stages, and the like can be used.

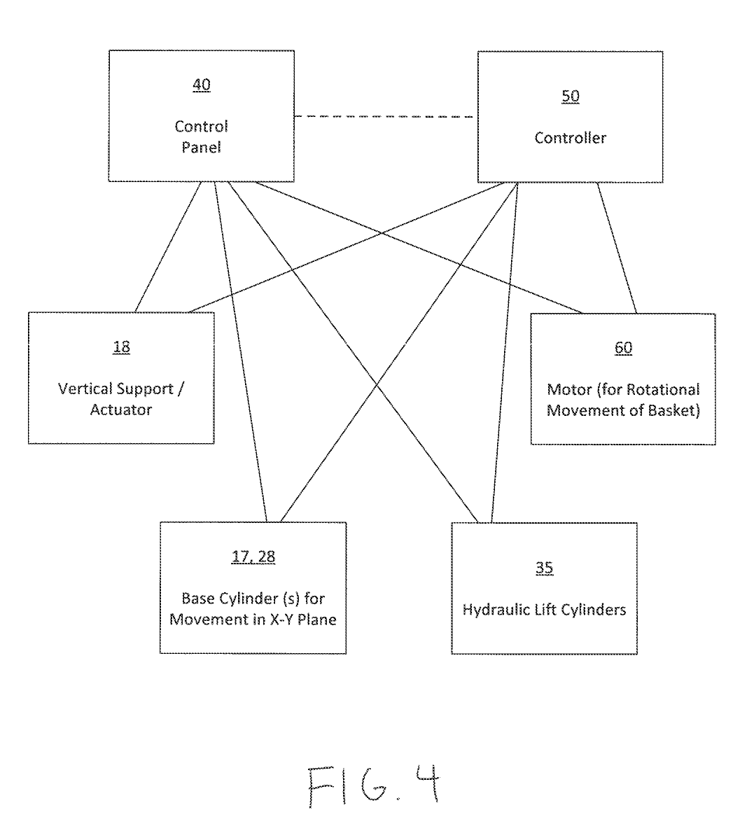

Optionally, the lift 10 can be provided as a component of a system 100 for inspecting a silo 12 as further disclosed herein. In exemplary aspects, and as shown in FIGS. 1A-1C and 4, the lift 10 can be supported on a trailer 14 or a portion of a vehicle, such as a truck bed. For example, in one optional aspect, the base 16 of the lift 10 can be pivotally coupled (e.g., pivotally secured) to the trailer 14. Optionally, the base 16 of the lift 10 can be pivotally coupled (e.g., pivotally secured) to the trailer using at least one pivot pin 30 as shown in FIG. 1C. In one exemplary aspect, it is contemplated that the at least one pivot pin can comprise at least one T-handle pin. In exemplary aspects, and as shown in FIG. 1A, it is contemplated that the base 16 can define a plurality of openings 39 that are configured to receive a pivot pin 30, thereby providing variation in the potential orientations of the lift 10 during transport. It is further contemplated that the pivot pin can be configured to pass through an aligned opening within a projection, plate, or door 70 that is secured to the trailer 14 or vehicle (optionally, extending upwardly from the trailer or vehicle), thereby providing selective, secure coupling between the base and the trailer or vehicle. It is still further contemplated that the pivot pin 30 can be selectively locked in place using conventional means. In use, and with reference to FIGS. 1A-1C, it is contemplated that the lift 10 can be pivoted to a horizontal, stowed position for transport and to a vertical position when in use for inspection of silos 12 as further disclosed herein, with the pivot pin 30 (e.g., T-handle pin) temporarily locking the lift in each respective position until a change in position is required (for use or transport). Thus, it is contemplated that the pivotal coupling between the base of the silo and the trailer can permit selective movement of the silo inspection lift about and between a horizontal, stowed position and a vertical, use position. Optionally, when the vertical support is fully retracted for transport, it is contemplated that a pivot pin can pass through openings within the base 16 that prevent vertical movement of the support arms 19 of the vertical support 18 until the pivot pin is removed. Thus, when transport is necessary, it is contemplated that the pivot pin can be removed to permit complete retraction of the vertical support, and the pivot pin can be inserted again following pivotal movement of the lift to the horizontal, stowed position. Optionally, the lift 10 can be permanently attached to the trailer 14 or vehicle. Alternatively, it is contemplated that the lift 10 can be selectively detachable from the trailer 14 or vehicle.

Optionally, in some exemplary aspects, the system 100 can comprise a platform 90 upon which the lift 10 is positioned. In these aspects, it is contemplated that the platform 90 can be coupled or otherwise secured to a plurality of hydraulic lift assemblies 35 using support arms 95 as shown in FIG. 3. It is further contemplated that the hydraulic lift assemblies 35 can be selectively activated using a control panel or controller 50 as further disclosed herein. Optionally, each hydraulic lift assembly 35 can comprise a respective lift cylinder and a plurality of telescopically coupled leg portions that are configured to engage a ground or road surface (or other support surface). Upon engagement between the hydraulic lift assemblies 35 and the support surface, the hydraulic lift assemblies can be selectively activated to lift the platform 90 to a desired height relative to the support surface (ground, road, etc.). In use, it is contemplated that the platform 90 can be bolted or otherwise secured to a trailer 14 or vehicle bed such that the hydraulic lift assemblies lift the platform, the lift, and the trailer or vehicle at the same time. It is further contemplated that the platform 90 can be selectively detached from the trailer 14 or vehicle bed to permit removal of the trailer and attachment to a different trailer or vehicle. In use, it is contemplated that the plurality of hydraulic lift assemblies 35 can be spaced about a perimeter of the platform 90 (and the perimeter of the trailer 14) to securely position the lift and the trailer at the work site and thereby provide a stable base for usage of the lift 10 as disclosed herein. It is further contemplated that the hydraulic lift assemblies 35 can provide additional height to the lift 10 when the fully extended height of the vertical support 18 is insufficient for a particular application/inspection. Optionally, the plurality of hydraulic lift assemblies can comprise four hydraulic lift assemblies that are positioned at respective corners of a trailer 14 and a platform 90.

Optionally, the platform 90 can comprise recessed portions that are configured to receive corresponding portions of the lift 10 when the lift is in the horizontal, stowed position. It is contemplated that these recessed portions can help limit movement of the lift during transport.

Optionally, it is contemplated that the basket 20 can be selectively removable from the vertical support 18. In some aspects, it is contemplated that the basket can be removed from the vertical support 18 during transport. However, it is also contemplated that the basket can be removed to permit replacement of a first basket with a second basket having a different size or shape or different operational features and capabilities.

Optionally, it is contemplated that the base 16 can be selectively removable from the vertical support 18. In some aspects, it is contemplated that the base can be removed from the vertical support 18 during transport. However, it is also contemplated that the base can be removed to permit replacement of a first base with a second base having a different size or shape or different operational features and capabilities.

In further exemplary aspects, when the lift is pivoted to a horizontal, stowed position as shown in FIG. 1C, it is contemplated that at least a portion of the lift can be supported by (e.g., rested on) a transport rest 25 that projects upwardly from an upper surface of the trailer 14 (or truck bed) or platform 90. In use, the transport rest 25 can be provided at a height that is sufficient to provide support and security to the lift during transport.

In still further exemplary aspects, and as shown in FIGS. 2A-2D, the top and bottom cover plates 36, 38 of the basket 20 can comprise respective lugs 29a, 29b that can be used to further secure the lift to the trailer (or truck bed) during transport. For example, it is contemplated that each lug can define a respective opening that is configured to receive rope, cable, a fastener, or other securing mechanism that is capable of coupling or securing the top and bottom cover plates to the trailer (or truck bed), which can optionally be equipped with a winch apparatus (e.g., for controlling the tension of cable or rope passed around a portion of the lift 10) or other corresponding lugs, hooks, or other conventional engagement features.

Optionally, as shown in FIGS. 1A-1B, the system 100 can further comprise at least one basket entry/exit apparatus positioned on the trailer. In one aspect, and as shown in FIG. 1A, the at least one basket entry/exit apparatus can comprise a ladder 27. Optionally, in this aspect, the ladder can be provided as a portion of a platform. In another aspect, and as shown in FIG. 1B, the at least one basket entry/exit apparatus can comprise stairs 26. More generally, in various aspects, the at least one basket entry/exit apparatus comprises a ladder, stairs, a platform, or combinations thereof In use, it is contemplated that the at least one basket entry/exit apparatus can assist an inspector during entry into the interior space 21 of the basket 20 or exit from the interior space of the basket.

The disclosed lift 10 can include operator controls in the man basket 20 or at other locations throughout the system 100. Optionally, in some aspects, and as shown in FIGS. 3-4, it is contemplated that the system 100 can comprise a control panel 40 that is positioned remote from the lift. Additionally, or alternatively, the system 100 can comprise a controller 50 that can be selectively activated by an inspector during use of the lift 10. Both the control panel 40 and the controller 50 can comprise remote computing devices, such as computers, tablets, smartphones, and the like, each of which can be equipped with processing circuitry and a memory in communication with the processing circuitry. In one exemplary configuration, the control panel 40 can be positioned on a trailer or truck bed as shown in FIG. 3, while the controller can be positioned onboard the lift (or, optionally, be carried by an inspector). It is contemplated that the control panel 40 and the controller 50 can operate either alone or in combination to control activation of the various components of the system 100, which can be communicatively coupled to the control panel and the controller through any conventional wired or wireless communication means, including Internet-, cellular-, or network-based communication. For example, it is contemplated that the control panel 40 and/or the controller 50 can be communicatively coupled to the vertical support 18 (i.e., the linear actuator), the hydraulic cylinders 28 coupled to the base 16, and the rotational actuator (i.e., motor 60) in order to permit selective vertical extension or retraction of the vertical support, selective two-dimensional horizontal and lateral motion of the lift (e.g., within the X-Y plane 4) using the at least one guide slide, and selective rotation of the basket 20 relative to the vertical axis 2. Additionally, it is contemplated that the control panel 40 and/or the controller 50 can be used to selectively deploy and retract one or more support platforms 22 using platform actuators as further disclosed herein. Additionally, it is contemplated that the control panel 40 and/or the controller 50 can be used to selectively deploy and retract the plurality of hydraulic lift assemblies 35 as further disclosed herein. Optionally, as shown in FIG. 3, it is contemplated that the control panel 40 can comprise an electrical control box 40a, hydraulic controls 40b, a hydraulic pump and/or electric motor 40c, and a hydraulic tank 40d that can optionally be communicatively coupled to the processing circuitry of the control panel (and/or the processing circuitry of the controller 50).

In use, the disclosed lift 10 can be used to inspect the interior space of a silo 12 as further disclosed herein. A method of inspecting the silo can comprise positioning the silo inspection lift in the vertical, use position as disclosed herein. After the lift is positioned in the vertical, use position, an inspector can enter the interior space of the basket as further disclosed herein. With an inspector positioned within the basket of the silo inspection lift, the method can further comprise selectively extending the vertical support until the basket containing the inspector passes through the discharge opening and is received within the interior space of the silo. As can be appreciated, during extension of the vertical support, the operative outer diameter of the basket can remain less than the diameter of the discharge opening until the basket has fully passed through the discharge opening (and the basket is fully received within the interior space of the silo). Following inspection of the interior of the silo, the method can further comprise selectively retracting the vertical support. For example, the vertical support can be retracted to a height at which the inspector can safely exit the basket. Optionally, following retraction of the vertical support, the basket can be positioned proximate a basket entry/exit apparatus as further disclosed herein.

In use, the lift 10 can be transported underneath a silo 12 and positioned so the basket 20 may fit through the opening of the cone of the silo when the vertical support is advanced. When the inspector enters the basket (prior to inspection), the inspector can close a gate of the basket. As further disclosed herein, the vertical support 18 can be extended so that the basket 20 is lifted into the silo 12. In addition to vertical movement of the basket, the method can further comprise selectively adjusting the lateral position of the lift 10 (e.g., within an X-Y plane 4) using at least one guide slide 17 as further disclosed herein. For example, it is contemplated that the lift can be moved off center of the silo discharge opening using an X Y axis base 16 as further disclosed herein. For example, in some aspects, after the basket is received within the interior space of the silo, the lift 10 (including the vertical support 18 and the basket 20) can be positioned off-center relative to the discharge opening, thereby providing sufficient clearance space for the inspector to exit the silo in the event of an emergency evacuation (while the lift remains in a use position in which the basket is positioned within the silo).

In use, it is contemplated that the disclosed method steps can be performed using a control panel 40 or controller 50 as further disclosed herein.

All publications and patent applications mentioned in the specification are indicative of the level of those skilled in the art to which this disclosure pertains. All publications and patent applications are herein incorporated by reference to the same extent as if each individual publication or patent application was specifically and individually indicated to be incorporated by reference.

Although the foregoing disclosure has been described in some detail by way of illustration and example for purposes of clarity of understanding, certain changes and modifications may be practiced within the scope of the appended claims.

What is claimed is:

1. A silo inspection lift comprising:
a base;
a vertical support extending from the base and having a top end, wherein the vertical support comprises at least one support arm that is selectively extendable and retractable relative to a vertical axis; and
a basket secured to the top end of the vertical support, wherein the basket defines an interior space configured to receive at least one human.

2. The silo inspection lift of claim 1, wherein the basket comprises a frame and at least one support platform that is coupled to the frame and selectively moveable about and between a retracted position and a deployed position, wherein in the deployed position, each support platform extends substantially perpendicularly to the vertical axis and is configured to support the at least one human when the at least one human is positioned on the platform.

3. The silo inspection lift of claim 2, wherein when the at least one platform is in the retracted position, the basket has an outer diameter ranging from about 20 inches to about 40 inches.

4. The silo inspection lift of claim 2, wherein each support platform of the at least one support platform is pivotally attached to the frame of the basket.

5. The silo inspection lift of claim 1, wherein the vertical support comprises a linear actuator that is configured to effect selective axial movement of the basket relative to the vertical axis.

6. The silo inspection lift of claim 5, wherein the linear actuator comprises a telescopic hydraulic cylinder comprising a plurality of telescopically coupled support arms.

7. The silo inspection lift of claim 1, wherein the basket is selectively rotatable relative to the vertical axis.

8. The silo inspection lift of claim 7, wherein the basket is rotatably coupled to the vertical support.

9. The silo inspection lift of claim 1, wherein the base comprises a base body and at least one linear guide slide, wherein the base body is movably coupled to the at least one linear guide slide to permit selective axial movement of the base body within a plane that is perpendicular to the vertical axis.

10. A system comprising:
a trailer; and
a silo inspection lift secured to the trailer and comprising:
a base;
a vertical support extending from the base and having a top end, wherein the vertical support comprises at least one support arm that is selectively extendable and retractable relative to a vertical axis; and
a basket secured to the top end of the vertical support, wherein the basket defines an interior space configured to receive at least one human,
wherein the base of the silo inspection lift is pivotally coupled to the trailer to permit selective movement of the silo inspection lift about and between a horizontal, stowed position and a vertical, use position.

11. The system of claim 10, wherein the basket of the silo inspection lift comprises a frame and at least one support platform that is coupled to the frame and selectively moveable about and between a retracted position and a deployed position, wherein in the deployed position, each support platform extends substantially perpendicularly to the vertical axis and is configured to support the at least one human when the at least one human is positioned on the platform of the silo inspection lift.

12. The system of claim 11, wherein when the at least one platform of the silo inspection lift is in the retracted position, the basket has an outer diameter ranging from about 12 inches to about 40 inches.

13. The system of claim 11, wherein each support platform of the at least one support platform of the silo inspection lift is pivotally attached to the frame of the basket.

14. The system of claim 10, wherein the vertical support of the silo inspection lift comprises a linear actuator that is configured to effect selective axial movement of the basket relative to the vertical axis.

15. The system of claim 14, wherein the linear actuator of the silo inspection lift comprises a telescopic hydraulic cylinder comprising a plurality of telescopically coupled support arms.

16. The system of claim 10, wherein the basket of the silo inspection lift is selectively rotatable relative to the vertical axis.

17. The system of claim 16, wherein the basket of the silo inspection lift is rotatably coupled to the vertical support.

18. The system of claim 10, wherein the base of the silo inspection lift comprises a base body and at least one linear guide slide, wherein the base body is movably coupled to the at least one linear guide slide to permit selective axial movement of the base body within a plane that is perpendicular to the vertical axis.

19. The system of claim 10, further comprising at least one basket entry/exit apparatus positioned on the trailer, wherein the at least one basket entry/exit apparatus comprises a ladder, stairs, a platform, or combinations thereof.

20. A method of inspecting a silo having an interior space and a discharge opening positioned in fluid communication with the interior space, the method comprising:
positioning a silo inspection lift in a vertical, use position, the silo inspection lift comprising:
a base;
a vertical support extending from the base and having a top end, wherein the vertical support comprises at least one support arm that is selectively extendable and retractable relative to a vertical axis; and
a basket secured to the top end of the vertical support;
with an inspector positioned within the basket of the silo inspection lift, selectively extending the vertical support until the basket containing the inspector passes through the discharge opening and is received within the interior space of the silo; and
selectively retracting the vertical support after the inspector has performed an inspection of the silo.
